(19) United States
(12) Patent Application Publication
(10) Pub. No.: US 2015/0163262 A1
(43) Pub. Date: Jun. 11, 2015

(54) AUTO-LAUNCH OF AUDIO/VIDEO CONFERENCE

(71) Applicant: International Business Machines Corporation, Armonk, NY (US)

(72) Inventors: Judith H. Bank, Cary, NC (US); Liam Harpur, Dublin (IE); Lin Sun, Morrisville, NC (US); Ruthie D. Lyle, Durham, NC (US); Patrick J. O'Sullivan, Dublin (IE)

(21) Appl. No.: 14/497,124

(22) Filed: Sep. 25, 2014

Related U.S. Application Data
(63) Continuation of application No. 14/097,594, filed on Dec. 5, 2013.

(51) Int. Cl. H04L 29/06

(52) U.S. Cl. CPC H04L 65/403; H04L 65/1066

(57) ABSTRACT

According to one aspect of the present disclosure, a method and technique for automatically launching an audio/video conference is disclosed. The method includes: receiving and storing, from a first user, an activity criterion; responsive to detecting an activity of the first user meeting the activity criterion, determining whether a second user meets the activity criterion; and responsive to determining that the second user meets the activity criterion, automatically initiating an electronic communication session between a computing device of the first user and a computing device of the second user.

### BACKGROUND

Computers, the Internet and various other types of telecommunication networks enable users to connect with others easily. For example, voice/video chat technologies on portable or non-portable computing devices, as well as telephones, enable participants to engage in live or real time communications with each other.

### BRIEF SUMMARY

According to one aspect of the present disclosure a method and technique for automatically launching an audio and/or video conference is disclosed. The method includes: receiving and storing, from a first user, an activity criterion; responsive to detecting an activity of the first user meeting the activity criterion, determining whether a second user meets the activity criterion; and responsive to determining that the second user meets the activity criterion, automatically initiating an electronic communication session between a computing device of the first user and a computing device of the second user.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of a network of data processing systems in which the illustrative embodiments of the present disclosure may be implemented;

FIG. 2 is an embodiment of a data processing system in which the illustrative embodiments of the present disclosure may be implemented;

FIG. 3 is a diagram illustrating an embodiment of a computing environment in which illustrative embodiments of a system for automatically launching an audio and/or video conference according to the present disclosure may be implemented; and

FIG. 4 is a flow diagram illustrating an embodiment of a method for automatically launching an audio and/or video conference according to the present disclosure.

### DETAILED DESCRIPTION

Embodiments of the present disclosure provide a method, system and computer program product for automatically launching an audio and/or video conference. For example, in some embodiments, the method and technique includes: receiving and storing, from a first user, an activity criterion; responsive to detecting an activity of the first user meeting the activity criterion, determining whether a second user meets the activity criterion; and responsive to determining that the second user meets the activity criterion, automatically initiating an electronic communication session between a computing device of the first user and a computing device of the second user. Thus, embodiments of the present disclosure enable a communication channel to be established (e.g., a video chat or audio chat) automatically (or in response to acceptance) with other users that may be performing the same or similar activities. The other users may be users identified via a social network, users that have similar interests or backgrounds, users located in a particular geographic region, or other criteria. Embodiments of the present disclosure enable a search to be automatically performed for other users performing the same or similar activities as the searching user and, if discovered, an electronic communication session may be automatically initiated with such discovered users. Thus, multiple users that may be engaging in a same or similar activity may be automatically conferenced together to enable such users to engage in the activity together (e.g., each participating in the same/similar activity while also communicating with other participants).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

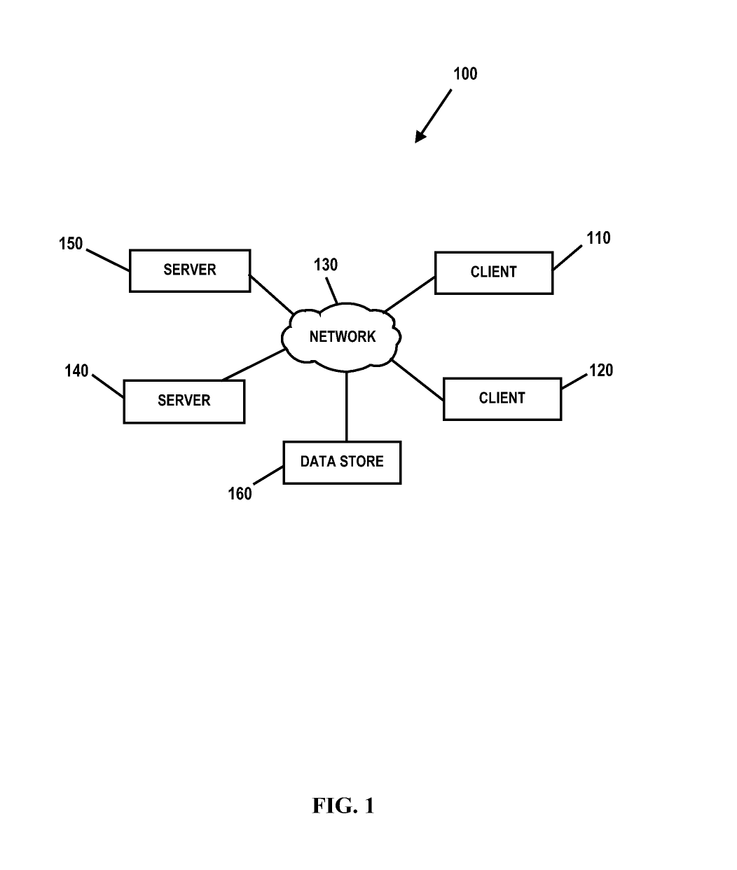

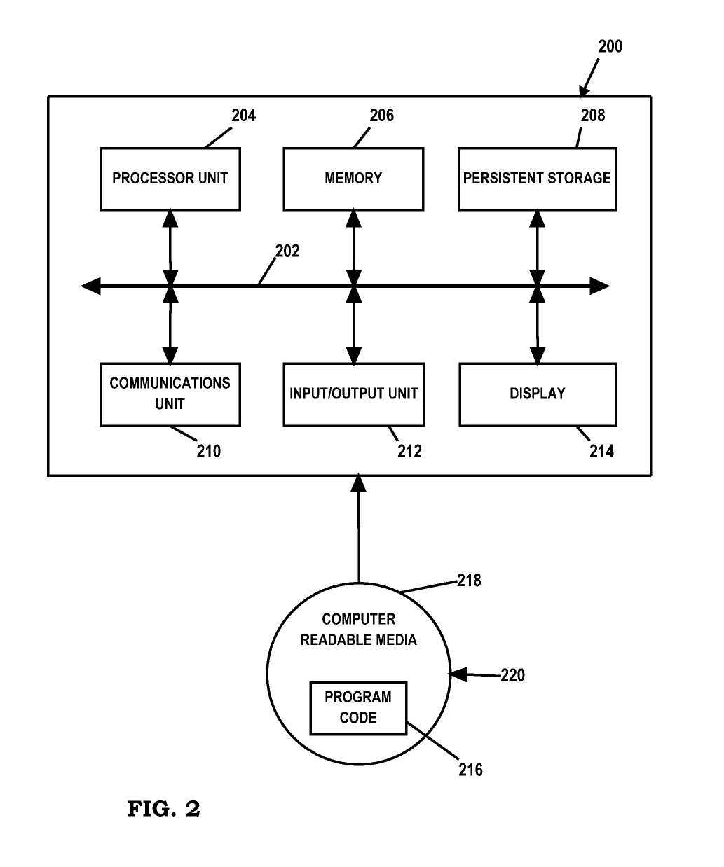

With reference now to the Figures and in particular with reference to FIGS. 1-2, exemplary diagrams of data processing environments are provided in which illustrative embodiments of the present disclosure may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments of the present disclosure may be implemented. Network data processing system 100 is a network of computers in which the illustrative embodiments of the present disclosure may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, server 140 and server 150 connect to network 130 along with data store 160. Server 140 and server 150 may be, for example, IBM® Power Systems™ servers. In addition, clients 110 and 120 connect to network 130. Clients 110 and 120 may be, for example, personal computers or network computers. In the depicted example, server 140 provides data and/or services such as, but not limited to, data files, operating system images, and applications to clients 110 and 120. Network data processing system 100 may include additional servers, clients, and other devices.

In the depicted example, network data processing system 100 is the Internet with network 130 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system 200 such as, but not limited to, client 110 and/or server 140 in which an embodiment of a system for automatically launching an audio and/or video conference according to the present disclosure may be implemented. In this embodiment, data processing system 200 includes a bus or communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

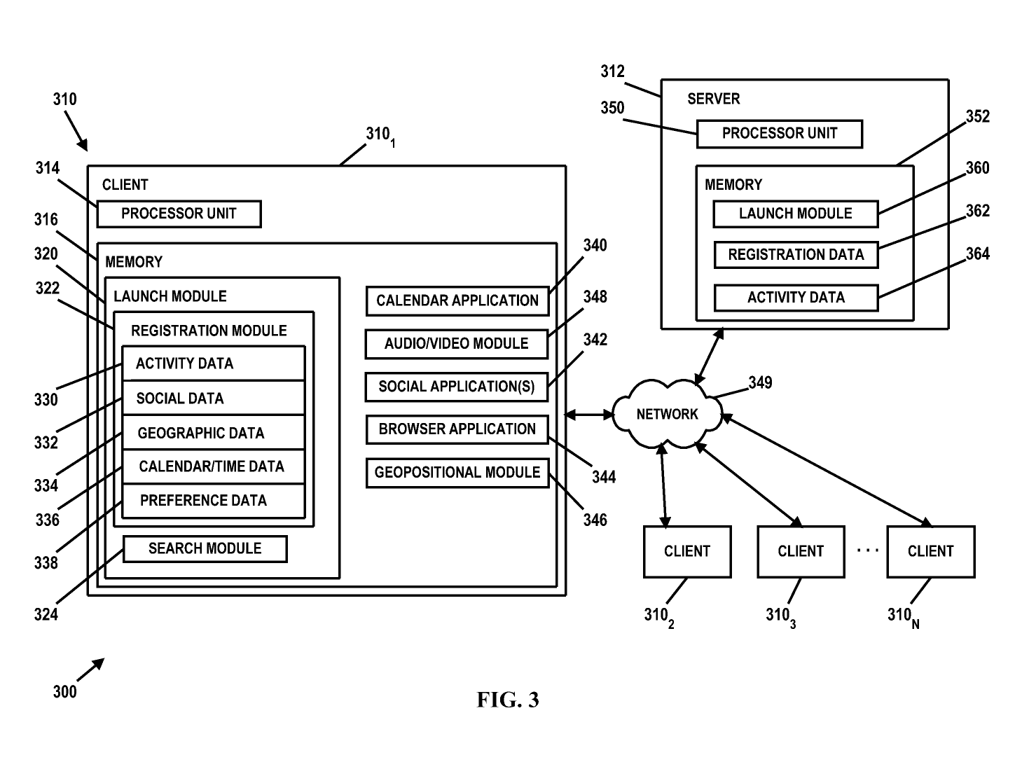

FIG. 3 is a diagram illustrating a computing environment in which an embodiment of a system 300 for automatically launching an audio and/or video conference according to the present disclosure may be implemented. In the illustrated embodiment, system 300 includes clients 310 (e.g., client 310₁₋ₙ) and a server 312 such as, but not limited to, client 110 and/or server 140. Clients 310 may comprise any type of computing device and/or data processing system such as, but not limited to, a desktop computer, laptop computer, tablet computer, portable telephone, or other type of portable or non-portable device. Clients 310 may each be configured similarly or have various configuration differences. For ease of description and illustration, client 310₁ will be described; however, it should be understood that clients 310₂₋ₙ may be configured to provide all or part of the functionality of client 310₁. In the illustrated embodiment, client 310₁ includes a processor unit 314 and a memory 316. In FIG. 3, memory 316 includes a launch module 320 for automatically launching and/or initiating an electronic communications session between client 310₁ and/or or more other clients 310 (e.g., clients 310₂₋ₙ) in response to two or more users of clients 310 performing, engaging in and/or otherwise participating in some activity. The communication session may be an audio communication/chat session, a video communication/chat session or another type of communication conference session. Launch module 320 may be implemented in any suitable manner using known techniques that may be hardware-based, software-based, or some combination of both. For example, launch module 320 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system).

In the illustrated embodiment, launch module 320 includes a registration module 322 and a search module 324. Registration module 322 may be used to receive and/or store various types of activity criteria that may be used to trigger and/or initiate a launch of a communication session. Registration module 322 may include and/or otherwise cause to be launched a graphical user interface (GUI) or other type of interface for receiving and storing various types of registration information. Search module 324 may be used to search for and/or otherwise determine whether a particular activity criterion has been met by a user of client 310. In the illustrated embodiment, registration module 322 includes activity data 330, social data 332, geographic data 334, calendar/time data 336 and preference data 338.

Activity data 330 may comprise information associated with one or more activities identified by a user that may cause a communication session to be automatically initiated with a client 310 of another user performing a same or similar activity. The activities may include participating in an on-line activity (e.g., watching a streaming video, shopping for clothing at an on-line website/store, etc.) or performing an off-line activity (e.g., performing some activity on the user's client 310 (such as playing a game or reading an electronic book) or watching a televised program). Social data 332 may comprise information associated with various social networks and/or contacts of a user. Social data 332 may also comprise other types of information pertaining to the user of client 310 and/or a desired similarity with other users for initiating a communication session with another user such as, but not limited to, membership and/or belonging to a particular group/club or employed by a particular employer, having a particular cultural background, having similar personality traits or interests, etc.

Geographic data 334 may comprise information associated with a certain geographic region of the user and/or certain geographic regions for limiting/defining a search for other users performing same/similar activities. For example, a user may specify the user's geographic location (e.g., current address/region) and/or specify geographic regions that may be searched for other users performing a same/similar activity. Geographic data 334 may also be used to configure when (or where) launch module 320 may initiate a communication session (e.g., only when the user is at home, never at work, at work during a lunch hour, etc.). Geographic data 334 and/or activity data 330 may also be configured to define when/where a communication session may be initiated (e.g., enable for code browsing activities at work, but disable for shopping activities). Calendar/time data 336 may comprise information associated with certain times and/or dates that the user may want or not want to have a communication session initiated. For example, the user may set launch module 320 to initiate a communication session only on certain days and/or only at certain times (e.g., between 9:00-10:00 P.M., never on Sundays, etc.).

Preference data 338 may comprise information associated with various preferences a user may define for configuring launch module 320. For example, preference data 338 may include information defining how close a particular activity should match to initiate a communication session (e.g., shopping generally, or shopping for certain types of goods/services), whether a search for other user's performing a same/similar activity should be limited to other user's within a particular social network, whether the user desires to have a communication session established with another user not currently known but residing in the same geographic region or having a similar interest/cultural background, whether the user desires to have a communication session established with only one user at a time or whether a communication session can be established with multiple users concurrently, etc. Preference data 338 may also be used to define whether the user desires to a communication session automatically initiated/established with another user or whether the user would prefer to be prompted with a summery/details of another discovered user to enable the user to accept/reject the communication session with the discovered user. For example, prior to establishing a communication session, the user may be presented with certain details of the discovered user (e.g., identity, corresponding matching activity, geographic location, etc.).

In the illustrated embodiment, memory 316 also includes a calendar application 340, one or more social applications 342, a web browser application 344, a geopositional module 346 and an audio/video module 348. Calendar application 340 may comprise a software program providing calendar/appointment and/or e-mail messaging functionality. Social application(s) 342 may comprise a software program and/or interface to a particular social network and/or on-line social community. Browser application 344 may comprise an Internet and/or web browser software program. Geopositional module 346 may comprise a GPS unit or other type of device for detecting and/or communicating a geopositional/geographic location of client 310. Audio/video module 348 may comprise an application and/or software program for controlling and/or otherwise managing the activation and/or use or various audio and/or video conferencing devices of client 310 and conferencing functions of clients 310 such as, but not limited to, a microphone, a video display, and a network connection to other clients 310 for such communication sessions via a network 349 (e.g., such as network 130).

In FIG. 3, system 300 also includes server 312 having a processor unit 350 and a memory 352. In FIG. 3, memory 352 includes a launch module 360, registration data 362 and activity data 364. Launch module 360 may be used to interface with various clients 310 registered with launch module 360 to determine/identify various activities being conducted by a user of a respective client 310 to determine whether such activity matches/corresponds to an activity of another user such that such corresponding activity may cause a communication session between such users to be launched/initiated. Launch module 352 may be implemented in any suitable manner using known techniques that may be hardware-based, software-based, or some combination of both. For example, launch module 352 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system).

Registration data 362 may comprise information associated with various registered users of clients 310 (e.g., information gathered via registration module 322). Activity data 364 may comprise information associated with activities being performed and/or otherwise engaged in by a particular user of a respective client 310. For example, in operation, a user may register with launch module 360 such that various types of registration information (e.g., activity criteria, social data, preference data, etc.) may be communicated to launch module 360 via network 349. Launch module 360 may interface with the various registered clients 310 do determine current activities being formed and/or scheduled to be performed to determine whether such activities match/correspond to another user. For example, launch module 320 of a respective client 310 may monitor various activities being performed on a particular client 310 and communicate such activity to launch module 360 (e.g., in real time or near real time). In some embodiments, the communication of such activity taking place on a particular client 310 may not take place to server 312 until polled by server 312. For example, in some embodiments, in response to an activity taking place on a particular client 310 meeting an activity criterion, such information may be communicated to launch module 360. Launch module 360 then polls other registered clients 310 to determine whether a matching activity is taking place on the respective clients 310. If so, such matching/correspondence may be communicated to a launch module 320 of a respective client 310 to enable such launch module 320 to automatically initiate/launch a communication session between such clients 310.

In operation, a user of client 310 (e.g., client 310₁ for example) may register various preferences, activities, social networks and/or social contacts and other information of which the user may desire to have a communication session initiated with another user performing the same/similar activity. For example, a user of client 310₁ may initiate browser application 344 and begin viewing an on-line exercise video from a remote website to facilitate partaking in an exercise routine by the user. Activity data 330 may identify such activity as being one that the user would desire to have a communication session established with one or more other users engaged in the same activity (e.g., other users identified from social data 332 or unknown users that may meet geographic or other criteria set by the user). Search module 324, in response to identifying that such activity is being performed by the user (or in anticipation of such activity taking place (e.g., via a calendar item in calendar application 340)), communicates with launch module 360 and, in turn, launch module 360 identifies and/or otherwise searches for other users performing the same or a similar activity via respective clients 310₂₋ₙ. In response to identifying and/or otherwise determining that another user is performing the same/similar activity, launch module 320 automatically initiates a communication session with clients 310₂₋ₙ. of such other users (e.g., via audio/video module 348), thereby enabling respective users to communicate with each other via clients 310 while participating in such activity.

As another example, a user of client 310₁ may launch browser application 344 and begin an on-line shopping session at a particular retailer website. Such activity may meet an activity criterion specified by the user such that other users also shopping online (e.g., other users within the user's social network or other users in the user's neighborhood) may be automatically identified and a communication session automatically initiated with such users.

In some embodiments, preference data 338 may be used to set various searching zones/parameters for identifying other users performing a same/similar activity. For example, in some embodiments, if launch module 320 is unable to discover any users within the social network contacts of the user, launch module 320 may then attempt a wider search on the user's extended social network contacts (e.g., indirect social network contacts such as other users within the same community or group as the current user). If launch module 320 still cannot discover any other user, launch module 320 will attempt a wider search to determine/identify another user (e.g., an unknown user that may have similar personality traits or a cultural background). If another user is discovered as a result of a search within a particular zone, launch module 320 may cease further searching and/or continue searching and prompt the user with further discovered users to determine whether the user desires to establish communication sessions with such further discovered users.

In some embodiments, in response to discovering/identifying other users as candidates for a communication session, before automatically launching/initiating the communication session, launch module 320 may display and/or otherwise present to the user information as to the discovered user. Launch module 320 may prompt the user for either acceptance or rejection of the communication session. At the conclusion of the particular activity (e.g., closing of browser application 344 and/or otherwise), launch module 320 may be configured to automatically terminate the communication session.

As indicated above, client 310 may be a portable device such that a geographic location of client 310 is subject to change. Geopositional module 346 may be used to determine/communicate a current location of client 310 to enable client 310 to be discovered by other users as well as discover other users within a geographic vicinity of the client 310.

Launch module 320 may also interface with calendar application 340 to alert other users as to a common activity. For example, in some embodiments, calendar application 340 may include scheduled items for various activities identified in activity data 330—as corresponding to an activity criterion where a user desires to have a communication session established with another user if possible/available when involved with such activity. Search module 324 may interface with launch module 360 in advance of such calendar item and invite other users (e.g., users meeting social data or other criteria) to join in such activity and establish a communication session with the respective user for such activity.

In some embodiments, social applications 342 may be used to establish a communication session with other users. In some embodiments, social applications 342 may be initiated and/or otherwise be active as a result of browsing activity conducted by browser application 344 (e.g., logging into an on-line social network via browsing application). Launch module 320 may interface with browser application 344 and/or social applications 342 to identify posts of activities being engaged in by the user (e.g., watching a televised program, eating dinner at a particular restaurant, etc.). If such activity meets a particular activity criterion, search module may initiate a search to discover other users within the user's social network (or other users engaged in a same/similar activity) to establish a communication session therewith.

In some embodiments, launch module 320 may also be configured to cause icons to be displayed to indicating that a user desires to participate in a shared activity such as watching a baseball game, watching a movie, doing homework, discussing a book, etc. Search module 324 may then search for other users indicating a same type of activity and display a list of related options. For example, if the user wanted to watch a sporting event, launch module 320 may display icons for all baseball games currently in session. When a user made a selection of a particular icon/sporting event, launch module 320 would interface with launch module 360 to thereby communicate such desire with other clients 310, thereby enabling other users to accept such activity and/or communication session related to such activity. The sporting event may be launched on each respective client 310 (e.g., via browser application 344 or otherwise) and a communication session would be established between clients 310 selecting to participate.

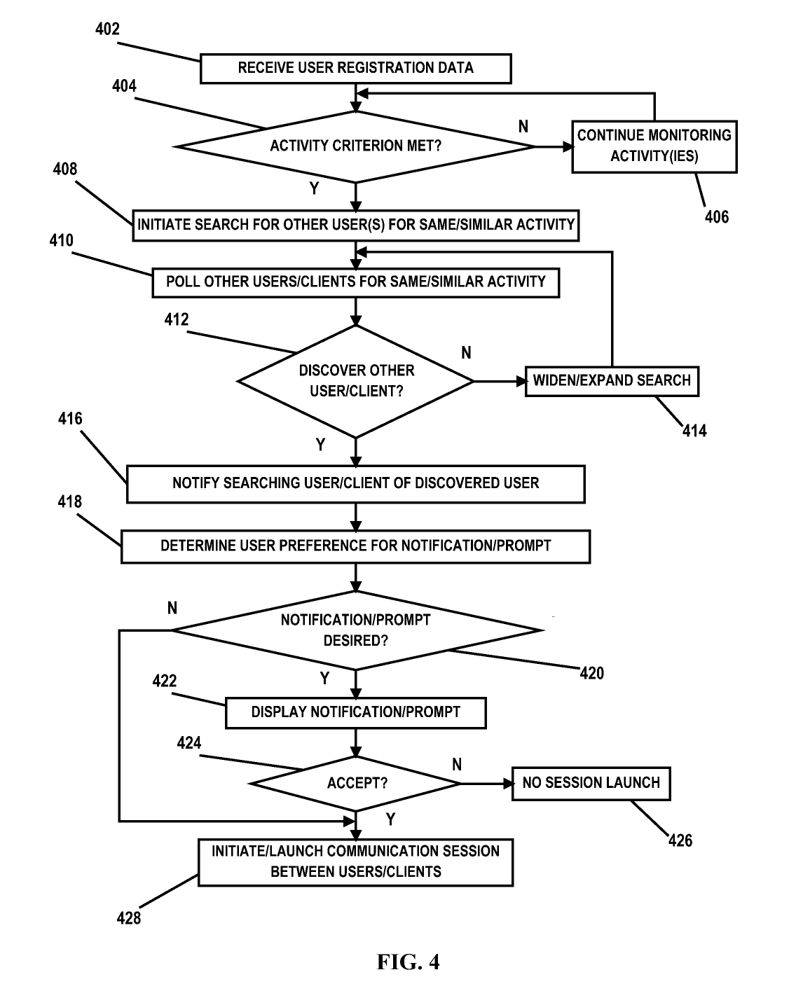

FIG. 4 is a flow diagram illustrating an embodiment of a method for automatically launching an audio and/or video conference according to the present disclosure. The method begins at block 402, where launch module 320 receives and stores registration information for a particular user (e.g., activity criteria, social network information, preference information, etc.). At block 404, launch module 320 may determine whether a particular activity being undertaken by a user of client 310 meets an activity criterion for the user. If not, the method proceeds to block 406, where launch module 320 may continue monitoring such activities. It should also be understood that in some embodiments, launch module 320 may be activated/engaged while a particular activity is being performed (e.g., while a user is watching an on-line video (even though such activity may not be a pre-registered activity criterion), the user may activate launch module 320 such that launch module 320 automatically considers such activity to meet an activity criterion.

If the activity meets an activity criterion, the method proceeds from decisional block 404 to block 408, where search module 324 interfaces with launch module 360 or server 312 to initiate a search for other users engaging in a same/similar activity (e.g., based on preference data). At block 410, launch module 360 may poll and/or otherwise interface with other clients 310 to assess activities being conducted by such other clients 310 (e.g., assess/analyze browsing activity, social network information to determine if such user is within the social network of the searching user, etc.). In some embodiments, launch module 360 may gather this activity-related information for clients 310 on a regular or periodic basis (e.g., in real time or near real time) and store such information as activity data, thereby enabling launch module 360 to expediently communicate the identity/candidacy of other users/clients meeting the search criteria.

At decisional block 412, a determination is made whether another user/client has been discovered matching the searched activity. If not, the method proceeds to block 414, where launch module 360 may widen the search (e.g., searching for other users outside the social network of the searching user). If another user/client has been discovered, the method proceeds from decisional block 412 to block 416, where launch module 360 may communicate information pertaining to the discovered user/client 310 to the searching client 310 (e.g., identity information, conferencing information (e.g., IP address or other information to enable audio/video module to establish a communication session therewith), etc.).

At block 418, launch module 320 determines preference information for the searching user to determine whether the user desires to be notified/prompted regarding such discovered user before initiating a communication session with the discovered user. The method then proceeds to decisional block 420, where a determination is made whether the user desires to receive notification information or an acceptance/rejection prompt regarding the discovered user. If so, the method proceeds to block 422, where launch module 320 displays a notification and/or prompt for acceptance/rejection for the session. At decisional block 424, a determination is made whether the user has accepted the prompt for the communication session. If not, the method proceeds and terminates at block 426, where no session is launched with the discovered user. If the prompt is accepted at decisional block 424, or no notification/prompt is desired at decisional block 420, the method proceeds to block 428, where launch module causes a communication session to be established with the discovered user/client 310.

Thus, embodiments of the present disclosure enable a communication channel to be established (e.g., a video chat or audio chat) automatically (or in response to acceptance) with other users that may be performing the same or similar activities. The other users may be users identified via a social network, users that have similar interests or backgrounds, users located in a particular geographic region, or other criteria. Embodiments of the present disclosure enable a search to be automatically performed for other users performing the same or similar activities as the searching user and, if discovered, an electronic communication session may be automatically initiated with such discovered users. Thus, multiple users that may be engaging in a same or similar activity may be automatically conferenced together to enable such users to engage in the activity together (e.g., each participating in the same/similar activity while also communicating with other participants).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method, comprising:
receiving and storing, from a first user, an activity criterion;
responsive to detecting an activity of the first user meeting the activity criterion, determining whether a second user meets the activity criterion; and
responsive to determining that the second user meets the activity criterion, automatically initiating an electronic communication session between a computing device of the first user and a computing device of the second user.

2. The method of claim 1, wherein automatically initiating the electronic communication session comprises automatically initiating an audio/video electronic communication session.

3. The method of claim 1, wherein receiving and storing the activity criterion comprises receiving and storing a social application activity.

4. The method of claim 1, wherein receiving and storing the activity criterion comprises receiving and storing a geographic criterion.

5. The method of claim 1, further comprising:
responsive to determining that the second user meets the activity criterion, displaying a prompt to the first user for accepting the electronic communication session; and
responsive to receiving an acceptance of the electronic communication session, automatically initiating the electronic communication session.

6. The method of claim 1, wherein receiving and storing the activity criterion comprises receiving and storing a time-related criterion for the activity criterion.

7. The method of claim 1, further comprising:
analyzing browsing activity associated with a browser application of the first computing device; and
determining whether the browsing activity meets the activity criterion.
